(19) United States
(12) Patent Application Publication
(10) Pub. No.: US 2011/0115674 A1
(43) Pub. Date: May 19, 2011

(54) SYSTEM AND METHOD FOR INTERROGATING A TARGET USING POLARIZED WAVES

(75) Inventor: Raymond J. Lackey, Bohemia, NY (US)

(73) Assignee: BAE Systems Information and Electronic Systems Integration Inc., Nashua, NH (US)

(21) Appl. No.: 12/618,001

(22) Filed: Nov. 13, 2009

(51) Int. Cl. H01Q 21/24; H01Q 13/02

(52) U.S. Cl. 342/361; 343/786

(57) ABSTRACT

A system and method for communication that could be used in an interrogate friend or foe system. The method comprises generating a first message by a processor and controlling a beam steerer to transmit waves polarized in a first polarization-direction toward a first spatial angle. The method further comprises transmitting the first message through an antenna in communication with the beam steerer toward the first spatial angle. The method further comprises receiving the first message at a target through a second antenna and generating a second message responsive to the first message by a second processor in communication with the second antenna. The method further comprises transmitting the second message in a responsive wave through the second antenna, the responsive wave polarized in a second polarization-direction distinct from the first polarization-direction; and receiving the responsive wave at the first antenna through the beam steerer.

### BACKGROUND OF THE INVENTION

1. Field of the Invention

This disclosure relates to millimeter (mm) wave communication and, more particularly, to a system and method for beam steering signals interrogating a target and receiving replies from the target using circularly polarized waves.

2. Description of the Related Art

Referring to FIG. 1, in a radar interrogation system 50, a processor 54 sends an interrogation message signal 70 through an antenna 52. An interrogation wave 56 is transmitted by antenna 52 typically in the radio frequency range. Interrogation wave 56 may be steered by a beam steerer 58 so that a transmitted wave 60 is directed toward a particular spatial-direction 0 because of phase adjustments by beam steerer 58. Wave 60 tends to be polarized in a particular polarization-direction. These may be linear or circularly polarized. Circularly polarized waves may be represented by orthogonal linear polarizations rotating in space and in time quadrature. That is, the electric field of wave 60 may rotate in a first polarization-direction (circular polarization) as wave 60 travels. As shown in the figure, wave 60 may have right hand circular polarization (RHCP)—i.e. from a frame of reference, the electric field rotates clockwise, looking in the spatial-direction of propagation. When wave 60 hits a target 64, wave 60 is partially reflected back as reflected wave 62 toward beam steerer 58 and antenna 52. Reflected wave 62, because of phase reversal in one of the linear components of the reflection, may have an electric field rotating a second polarization-direction opposite the first polarization-direction, counter clockwise, looking in the spatial-direction of propagation, or left hand circularly polarized (LHCP). In the figure, reflected wave 62 is left hand circular polarized. Reflected wave 62 is received by antenna 52, converted into a received signal (not shown) and processed by processor 54. In this way, processor 54 can determine whether target 64 is near antenna 52 at spatial angle θ. This disclosure relates to an improvement over these prior art technologies.

### SUMMARY OF THE INVENTION

One embodiment of the invention is a method for communicating. The method comprises generating a first message by a first processor; controlling a beam steerer to transmit waves polarized in a first polarization-direction toward a first spatial angle; and transmitting the first message through a first antenna in communication with the beam steerer toward the first spatial angle. The method further comprises receiving the first message at a target through a second antenna; generating a second message responsive to the first message by a second processor in communication with the second antenna; transmitting the second message in a responsive wave through the second antenna, the responsive wave polarized in a second polarization-direction distinct from the first polarization-direction; and receiving the responsive wave at the first antenna through the beam steerer.

Another embodiment of the invention is a communication system. The system comprises a first processor; a first antenna in communication with the first processor; and a beam steerer in communication with the first antenna and the first processor. The first processor is effective to generate a first message; control the beam steerer to transmit waves polarized in a first polarization-direction toward a first spatial angle; and cause the first antenna to transmit the first message toward the first spatial angle. The system further comprises a second processor; a second antenna in communication with the second processor, the second antenna effective to receive the first message. The second processor is further effective to receive the first message from the second antenna and to generate a second message responsive to the first message, the second processor further effective to cause the second antenna to transmit the second message in a responsive wave polarized in a second polarization-direction distinct from the first polarization-direction. The first antenna is effective to receive the second message in the responsive wave.

Yet another embodiment of the invention is a method for communicating. The method comprises generating a first message by a first processor; controlling a beam steerer to transmit waves polarized in a first polarization-direction toward a first spatial angle; and transmitting the first message through a first antenna in communication with the beam steerer toward the first spatial angle. The method further comprises receiving a second message at a target through a second antenna; generating a third message responsive to the second message by a second processor in communication with the second antenna; and transmitting the third message in a responsive wave through the second antenna, the responsive wave polarized in a second polarization-direction distinct from the first polarization-direction. The method further comprises receiving the responsive wave at the first antenna through the beam steerer simultaneous with the transmitting the first message.

### BRIEF DESCRIPTION OF THE DRAWINGS

The drawings constitute a part of the specification and include exemplary embodiments of the present invention and illustrate various objects and features thereof.

FIG. 1 is a system drawing of a prior art radar system.

FIG. 2 is a system drawing of an interrogation system.

FIG. 3A is a system drawing of a communication system in accordance with an embodiment of the invention.

FIG. 3B is a system drawing of a communication system in accordance with an embodiment of the invention.

FIG. 4 is a perspective view of a prior art beam steerer.

FIG. 5 is a flow chart of a process for communicating with a target in accordance with an embodiment of the invention.

### DETAILED DESCRIPTION OF THE PREFERRED EMBODIMENT(S)

Various embodiments of the invention are described hereinafter with reference to the figures. Elements of like structures or function are represented with like reference numerals throughout the figures. The figures are only intended to facilitate the description of the invention or as a guide on the scope of the invention. In addition, an aspect described in conjunction with a particular embodiment of the invention is not necessarily limited to that embodiment and can be practiced in conjunction with any other embodiments of the invention.

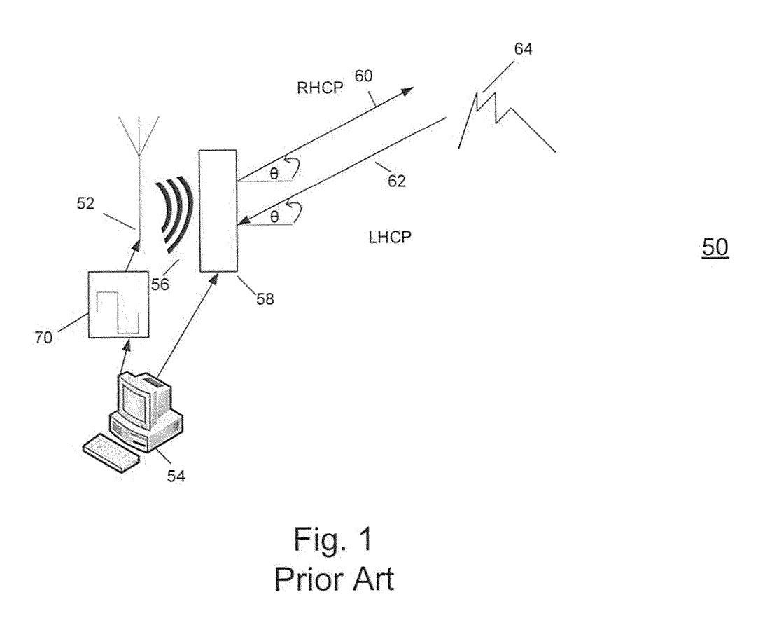

Referring still to FIG. 1, the prior art systems described above work well for a radar based arrangement where a wave reflected off of a target is processed by processor 54. As beam steerer 58 steers wave 60 toward target 64 at spatial angle θ, waves polarized in a first polarization-direction are emitted (right hand circular polarized waves are shown). Simultaneously, beam steerer 58 is set up to receive waves 62 polarized in a second polarization-direction (left hand circular polarized waves arc shown).

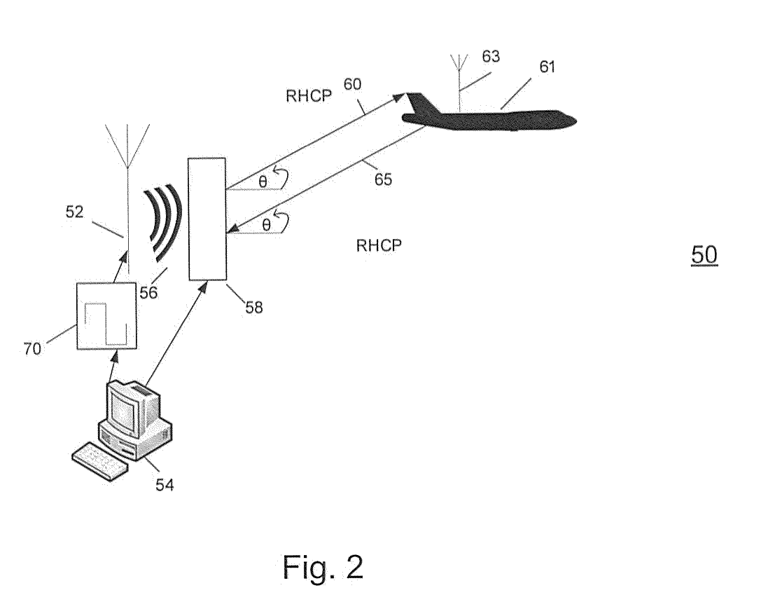

However, such systems have significant deficiencies in identification friend or foe (IFF) applications where the target includes a transponder that radiates a wave with the same polarization as the interrogation. Referring to FIG. 2, target 61 would receive interrogation wave 60 and then transmit a responsive wave 65 from an antenna 63. That responsive wave 65 likely will include waves also polarized in the first polarization-direction. The prior art system of FIG. 1 with beam steerer 58 is not oriented to receive responsive wave 65 and responsive wave 65 will either not be detected at all or may lose significant gain before being processed by processor 54.

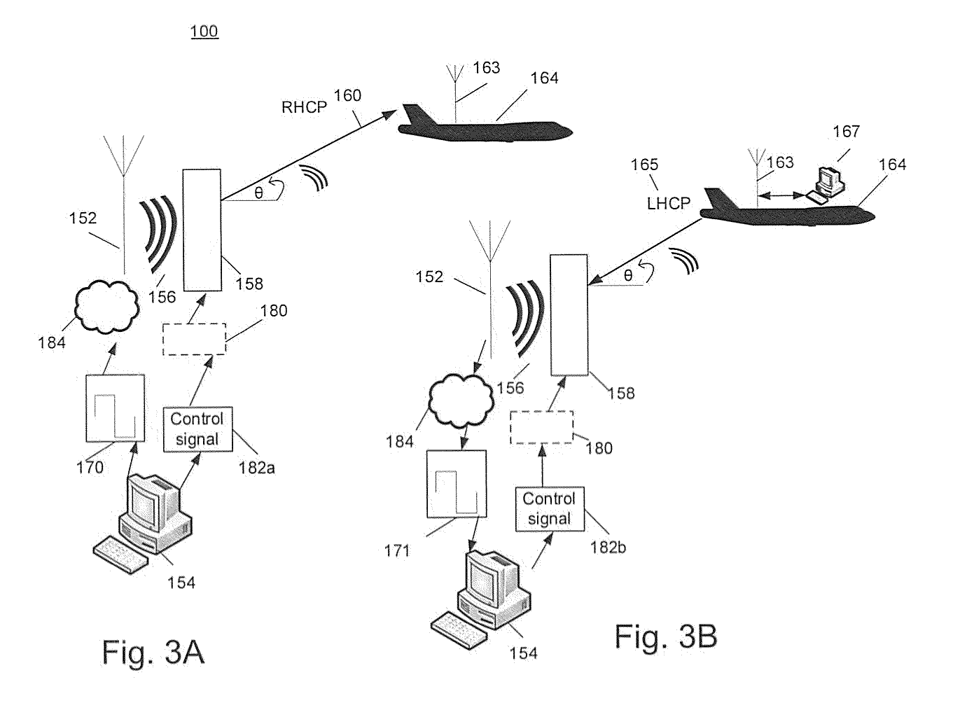

Referring to FIG. 3A, there is shown a communication system which overcomes the above deficiencies and could be an interrogation system 100 in accordance with an embodiment of the invention. The discussion below relates to use in an IFF system though it should be clear that the system would work with any data link. In system 100, a processor 154 sends an interrogation message 170 to an antenna 152 perhaps through an RF feed network 184 all in communication with each other. RF feed network 184 could be a single port or multiple ports. Multiple ports could be used with a coupler for sum and difference processing such as may be used to sharpen an effective beam width of antenna 152. Antenna 152 could be any type of antenna such as, for example, a single horn, multiple horns connected through a coupler, a flat plate array, or any arrangement of antenna that can form a plane wave. Antenna 152 could be dual polarized so that antenna 152 may selectively transmit RHCP or LHCP waves. An interrogation wave 156 is transmitted by antenna 152 typically in the radio frequency range. Interrogation wave 156 may be steered by a beam steerer 158 in communication with antenna 152 so that a transmitted wave 160 is directed toward spatial angle θ. Beam steerer 158, in turn, may be controlled by processor 154 generating control signals 182 to beam steerer 158 and/or a control circuit 180. Wave 160 tends to be polarized in a particular polarization-direction. That is, the electric field of wave 160 may rotate in a first particular polarization-direction (circular polarization) as wave 160 travels. As shown in the figure, wave 160 may have right hand circular polarization (RHCP)—i.e. from a frame of reference, the electric field rotates clockwise.

Referring now also to FIG. 3B, when wave 160 is received by target 164, a processor 167 at target 164 in communication with antenna 163 generates a responsive wave 165 from an antenna 163 directed toward beam steerer 158 and antenna 152. Antenna 163 could similarly be any antenna including a dual polarized antenna. Response wave 165 is responsive to interrogation message 170 and includes an interrogation response 171. Responsive wave 165 is polarized in a second polarization-direction—opposite to the first polarization-direction. Response wave 165 is transmitted using waves with left hand circular polarization, which is opposite to the conventional case where transmitters in a system all transmit with the same polarity. Processor 154 maintains control signals 182b to beam steerer 158 or circuit 180 to control beam steerer 158 to now receive right hand circular polarized waves at spatial angle θ. This is because when beam steerer 158 is oriented to transmit right hand circular polarized waves at spatial angle θ, beam steerer 158 is simultaneously oriented to receive left hand circular polarized waves at spatial angle θ. Responsive wave 165 is received by beam steerer 158 and antenna 152, sent through feed network 184, converted into interrogation response 171 and processed by processor 154. In this way, processor 154 can determine whether target 164 is near antenna 152 at spatial angle θ. Processor 154 can also simultaneously transmit transmitted wave 160 and receive responsive wave 165 perhaps in response to a previously transmitted wave 160. Antennas 152 and 163 may have isolation between transmit and receive signal paths such as by orthogonal feed networks of right and left circular polarization. This allows for higher communication rates than that available in the prior art.

Beam steerer 158 is independent of the antenna 152 feeding beam steerer 158 so that antenna 152 can be a more complex antenna with sum and difference capability as is currently used in many identification friend or foe systems for effective beam sharpening. As circular polarizations are comprised of phased horizontal and vertical polarization vectors, antenna 158 could also be comprised of a complex antenna structure capable of transmitting and receiving in horizontal and vertical polarization. A coupler could be used to generate both right-handed and left-handed polarization and separate the two signals. Antenna 152 could generate sum illumination with a single main lobe and/or difference illumination with a double lobed antenna pattern with opposite phases to increase accuracy or exclude target responses or signal clutter.

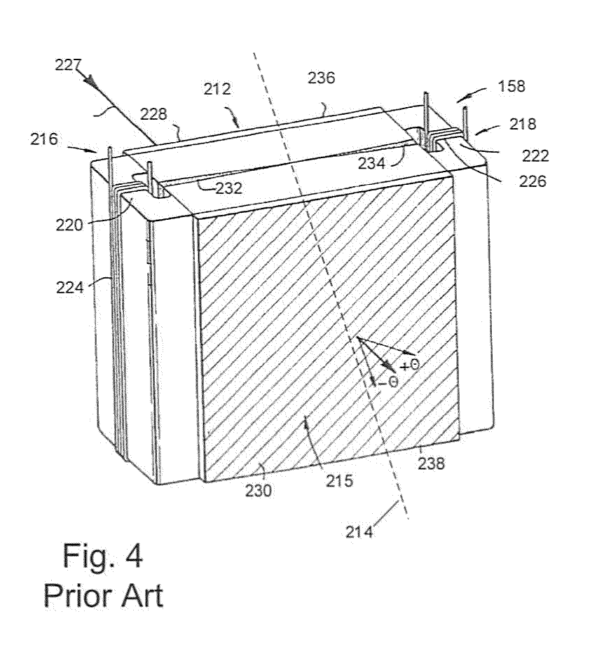

Beam steerer 158 may be a beam steerer like that shown in U.S. Pat. No. 6,320,551, the entirety of which is hereby incorporated by reference. Referring to FIG. 4, there is shown a reproduction of a figure describing the beam steerer in U.S. Pat. No. 6,320,551. This beam steerer uses a single control over the entire antenna. This significantly reduces the cost of the beam steered antenna, making it useful for large volume mm wave applications requiring beam steering, such as IFF interrogation applications.

Beam steerer 158 comprises a body 212 which is symmetrical about a central plane 214. At ends 216, 218 of body 212 are separate end pieces 220, 222 which carry coils 224, 226. Coils 224, 226 have parallel axes which are orientated normal to a front face 228 and a rear face 230 of body 212. A region of body 212 between the coils 224, 226, comprises an aperture 215 through which a wave 227 may pass.

End pieces 220, 222 are made of a material which is different to the material of body 212 of beam steerer 158. End pieces 220, 222 are of a material having a high magnetization such as mild steel or Swedish iron. Although end pieces 220, 222 are usually uniform, end pieces 220, 222 may be in the form of a laminated stack to reduce eddy currents. In fact, body 212 may itself be in a laminated form. Alternatively end pieces 220, 222′ may be an integral part of body 212.

Body 212 comprises ferrite material having a permeability which is dependent on a magnetic field to which the body is subjected. A suitable ferrite material is TTI-3000 which is manufactured by Trans-tech Inc. Extending from ends 216, 218 towards central plane 214 are tapered slots or gaps which are filled with dielectric inserts 232, 234 having a permittivity identical to or similar to that of the ferrite material. A suitable material for the inserts is D13 manufactured by Trans-tech Inc. Although the permittivities of the ferrite material and the insert material are substantially the same, the magnetic permeability of the insert material is lower than that of the ferrite material. As a result, inserts 232, 234 present a relatively high reluctance path or barrier through the body 212 to a magnetic field applied by the coils 224, 226. At a location near coils 224, 226 the reluctance through body 212 is relatively high compared to a body of uniform composition. The reluctance diminishes along the tapered inserts towards the central plane.

Ideally the permeability of inserts 232, 234 is unity although the permittivity may be higher. The permeability of inserts 232, 234 should be less than the permeability of the ferrite material of body 212. The high reluctance paths provided by the insert material present a reluctance to the magnetic flux and the lines of magnetic force shift along the tapered inserts away from the coils 216, 218 to a narrower part of the insert or to a region of the aperture 215 free of inserts 232, 234.

Consequently, inserts 232, 234 force the lines of magnetic force further inward towards the central plane 214 than would be the case in an un-slotted device and a more controlled and uniform gradient in magnetic flux across aperture 215 is obtained.

The length of the slots is dependent upon the width of beam steerer 158, although as a guide each slot should extend from its respective coil about a third of the distance between the coils. For example, beam steerer 158 may have an aperture of dimensions 75 mm×75 mm. Body 212 has a thickness of about 25 mm. The slots are approximately 30 mm long and taper down from 1.0 mm to zero.

The reluctance of body 212 across its thickness where the slots are not present may be about 9×10⁻⁴H⁻¹. The reluctance of body 212 across its thickness where a dielectric material insert of 0.1 mm thickness (having a permeability of unity) is present may be about 13×10⁻³H⁻¹.

In use, coils 224, 226 are energized by a current source so that the magnetic field produced by coils 224, 226 is in a direction generally normal to faces 228; 230. The magnetic field produced by coil 224 is in an opposite direction to the magnetic field produced by the coil 226. There is thus no magnetic field across central plane 214 if coils 224, 226 are energized equally.

As discussed above, wave 227 is a circularly polarized wave directed centrally onto face 228 of beam steerer 158 in a spatial-direction normal to face 228 by means of a suitable lens arrangement such as a dielectric lens. Wave 227 emerges un-deviated from the face 230 if no current or equal current is flowing in coils 216, 218.

When a current flows through coils 216, 218 wave 227 emerges from beam steerer 157 at a spatial angle θ degrees to the central plane 214. The deflection of wave 227 arises as a result of differential phase shift along line 214 drawn between coils 216, 218. This differential phase shift is caused by the gradient in magnetization across aperture 215 induced by magnetic fields generated by coils 216, 218. A first magnetic field between central plane 214 and end 216 is in a first direction and a second magnetic field between central plane 214 and end 218 is in a second direction opposite to the first direction. Since the permeability of the ferrite depends on the direction and magnitude of the magnetic field, the phase shift experienced by wave 227 will vary across a width of beam steerer 158 and the wave 227 is thus deflected. To deflect wave 227 in an opposite direction, the direction of current flow in coils 216, 218 is reversed to switch the directions of the magnetic fields and have a corresponding effect on the magnetization. This results in the wave 227 wave emerging from beam steerer 158 in a spatial-direction at a spatial angle θ degrees to central plane 214.

Beam steerer 158 shown in FIG. 4 or a similar arrangement may be used in system 100 shown in FIG. 3A. Control signal 182a could be used to control current applied to coils 216, 218 to direct interrogation wave 160 to be transmitted at spatial angle θ for right hand circular polarization at a first time. Thereafter, as shown in FIG. 3B, control signal 182b could be used to control current to be applied to coils 216, 218 to receive waves at spatial angle θ including responsive wave 165 sent using left hand circular polarization.

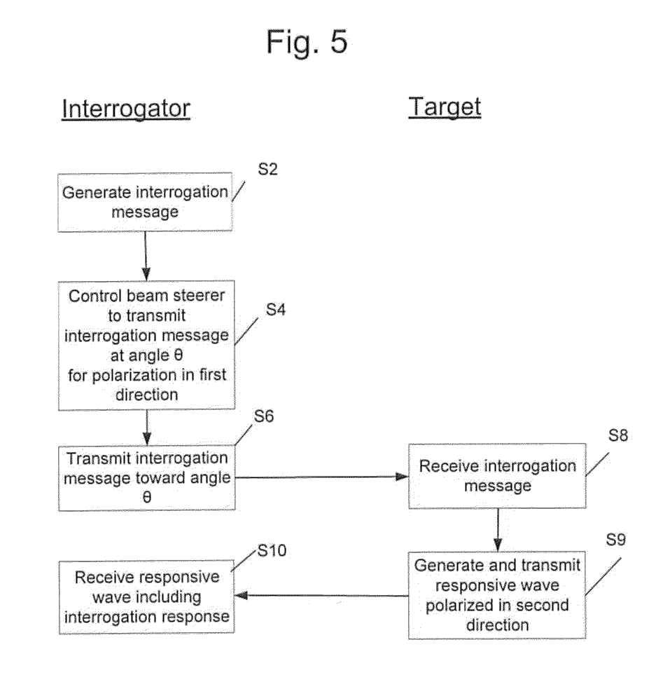

Referring to FIG. 5, there is shown a flow chart of a process which could be performed in accordance with an embodiment of the invention. The process could be performed using, for example, system 100 described above. As shown, at step S2, a processor at an interrogator generates an interrogation message to be transmitted to a target. Such a message may be used to determine whether the target is friend or foe. At step S4, the processor controls a beam steerer to transmit the interrogation message at a spatial angle θ for outward bound waves polarized in a first polarization-direction—such as right hand circular polarization. At step S6, the processor transmits the interrogation message through an antenna and the beam steerer at spatial angle θ.

At step S8, the target receives the interrogation message. At step S9, the target generates and transmits a responsive wave polarized in a second polarization-direction—such as left hand circular polarization. At step S10, the processor receives the responsive wave through the beam steerer and the antenna. Thereafter, the responsive wave including an interrogation response may be processed by the processor.

While the invention has been described with reference to a number of exemplary embodiments, it will be understood by those skilled in the art that various changes can be made and equivalents can be substituted for elements thereof without departing from the scope of the invention. In addition, many modifications can be made to adapt a particular situation or material to the teachings of the invention without departing from essential scope thereof. Therefore, it is intended that the invention not be limited to any particular exemplary embodiment disclosed herein.

What is claimed is:

1. A method for communicating, the method comprising:
generating a first message by a first processor;
controlling a beam steerer to transmit waves polarized in a first polarization-direction toward a first spatial angle;
transmitting the first message through a first antenna in communication with the beam steerer toward the first spatial angle;
receiving the first message at a target through a second antenna;
generating a second message responsive to the first message by a second processor in communication with the second antenna;
transmitting the second message in a responsive wave through the second antenna, the responsive wave polarized in a second polarization-direction distinct from the first polarization-direction; and
receiving the responsive wave at the first antenna through the beam steerer.

2. The method as recited in claim 1, wherein the first polarization-direction is opposite to the second polarization-direction.

3. The method as recited in claim 1, wherein the controlling the beam steerer includes applying a current to the beam steerer.

4. The method as recited in claim 1, wherein the first antenna is a horn antenna.

5. The method as recited in claim 1, wherein the first antenna is a flat plate antenna.

6. The method as recited in claim 1, wherein:
the first antenna is effective to transmit sum illumination;
the first antenna is effective to receive waves as difference illumination; and
the method further comprises separating the sum illumination and the difference illumination using a coupler in communication with the first antenna.

7. The method as recited in claim 1, wherein:
the first antenna is effective to transmit waves polarized in the first polarization-direction;
the first antenna is effective to receive waves polarized in the second polarization-direction; and
the method further comprises separating waves polarized in the first and second polarization-direction using a coupler in communication with the first antenna.

8. The method as recited in claim 1, wherein the first message is an interrogation message.

9. A communication system, the system comprising:
a first processor;
a first antenna in communication with the first processor; and
a beam steerer in communication with the first antenna and the first processor;
wherein the first processor is effective to
generate a first message;
control the beam steerer to transmit waves polarized in a first polarization-direction toward a first spatial angle; and
cause the first antenna to transmit the first message toward the first spatial angle;
a second processor;
a second antenna in communication with the second processor, the second antenna effective to receive the first message;
the second processor effective to receive the first message from the second antenna and to generate a second message responsive to the first message, the second processor further effective to cause the second antenna to transmit the second message in a responsive wave polarized in a second polarization-direction distinct from the first polarization-direction; and
the first antenna effective to receive the second message in the responsive wave.

10. The system as recited in claim 8, wherein the control the beam steerer includes applying a current to the beam steerer.

11. The system as recited in claim 9, wherein the first antenna is a horn antenna.

12. The system as recited in claim 9, wherein the first antenna is a flat plate antenna.

13. The system as recited in claim 9, wherein:
the first antenna is effective to transmit sum illumination;
the first antenna is effective to receive waves as difference illumination; and the system further comprises
a coupler in communication with the first antenna, the coupler effective to separate the sum illumination and the difference illumination.

14. The system as recited in claim 8, wherein:
the first antenna is effective to transmit waves polarized in the first polarization-direction;
the first antenna is effective to receive waves polarized in the second polarization-direction; and the system further comprises
a coupler in communication with the first antenna, the coupler effective to separate the waves polarized in the first and second polarization-direction.

15. The system as recited in claim 8, wherein the first message is an interrogation message.

16. A method for communicating, the method comprising:
generating a first message by a first processor;
controlling a beam steerer to transmit waves polarized in a first polarization-direction toward a first spatial angle;
transmitting the first message through a first antenna in communication with the beam steerer toward the first spatial angle;
receiving a second message at a target through a second antenna;
generating a third message responsive to the second message by a second processor in communication with the second antenna;
transmitting the third message in a responsive wave through the second antenna, the responsive wave polarized in a second polarization-direction distinct from the first polarization-direction;
receiving the responsive wave at the first antenna through the beam steerer simultaneous with the transmitting the first message.

17. The method as recited in claim 16, wherein the first and second messages are distinct.

18. The method as recited in claim 16, wherein the first polarization-direction is opposite to the second polarization-direction.

19. The method as recited in claim 16, wherein:
the first antenna is effective to transmit sum illumination;
the first antenna is effective to receive waves as difference illumination; and
the method further comprises separating the sum illumination and the difference illumination using a coupler in communication with the first antenna.

20. The method as recited in claim 16, wherein:
the first antenna is effective to transmit waves polarized in the first polarization-direction;
the first antenna is effective to receive waves polarized in the second polarization-direction; and
the method further comprises separating waves polarized in the first and second polarization-direction using a coupler in communication with the first antenna.
